(19) United States
(12) Patent Application Publication
(10) Pub. No.: US 2014/0172541 A1
(43) Pub. Date: Jun. 19, 2014

(54) Generating Metrics Based on Client Device Ownership

(71) Applicant: Facebook, Inc., Menlo Park, CA (US)

(72) Inventors: Sean Michael Bruich, Palo Alto, CA (US); Frederick Ross Leach, San Francisco, CA (US)

(73) Assignee: Facebook, Inc., Menlo Park, CA (US)

(21) Appl. No.: 13/713,459

(22) Filed: Dec. 13, 2012

(51) Int. Cl. G06Q 30/02; G06Q 50/00

(52) U.S. Cl. CPC G06Q 30/0242; G06Q 50/01
USPC 705/14.43; 705/14.45

(57) ABSTRACT

A social networking system generates metrics for one or more advertisements based on client device ownership. Social networking system users are identified as owners of client devices. For example, a social networking system user is identified as owning a client device if the user's user account was accessed using a native software application or a web browsing application associated with the client device. Exposures to one or more advertisements by the identified owners are determined and used to generate advertising metrics with respect to the client devices owned by the owners. The metrics may be segmented or organized based on various client device types.

### BACKGROUND

This invention generally relates to generating metrics, and more specifically to generating metrics based on client device ownership.

Advertisers expend significant resources on advertisements promoting their products or services. Often, advertisers communicate advertisements to potential customers using various forms of media including television, newspapers, radio, cinema, billboards, the Internet and/or the like. In recent years, the online distribution of advertisements (e.g., distribution via the Internet) has become increasingly popular among advertisers.

Advertisers are frequently interested in measuring the effectiveness of their advertisements on different groups of people. For example, an advertiser may be interested in measuring the effectiveness of its advertisements presented to owners of various client devices. To generate metrics describing the effectiveness of advertising, associations between exposure to advertisements and ownership of the client devices are needed. Determining device ownership and advertisement associations is generally a manual process that is often subject to reporting inaccuracies. Accordingly, conventionally generating advertising metrics based on client device ownership is a laborious task producing imprecise results.

### SUMMARY

Embodiments of the invention are directed to generating metrics for one or more advertisements based on ownership of client devices. To generate the metrics, a social networking system automatically identifies users of the social networking system as owners of various client devices (e.g., mobile phones, tablet devices, etc.). In one implementation, the social networking system identifies a user as an owner of a client device if the user's account on the social networking system has been accessed by a native software application or by a web browsing application installed on the client device. In one embodiment, to more accurately identify owners, the social networking system identifies a user as an owner of a client device after the user's account is accessed by the native software application or by the web browsing application at least a threshold number of times or at least a threshold percentage of times. In other embodiments, the social networking system also analyzes social signals from data maintained by the social networking system to identify whether a user is an owner of a client device. For example, ownership may be determined based on information in the user profiles or other content of a user's friends over the social networking system. Illustratively, a comment posted by a user's friend to the social networking system may congratulate the user for purchasing a particular mobile phone model.

After identifying owners of various client devices, the social networking system identifies one or more exposures of the identified owners to one or more advertisements. The social networking system also obtains additional information associated with the owners of the various client devices. Examples of the additional information include purchase transaction information, observed online and offline user actions, polling data, or any other information suitable for generating advertising metrics.

Based on the advertisement exposures and/or the obtained additional information, the social networking system generates various metrics for the one or more advertisements with respect to the identified owners. In one aspect, the generated metrics may be broken down according to types for the various client devices. For example, the generated metrics may be segmented based on client device model, product number, operating system, manufacturer, etc. As an example, different metrics may be generated for the owners of the APPLE® IPHONE®4, the APPLE® IPAD®, and the Amazon KINDLE FIRE®.

In one embodiment, metrics generated by the social networking system may describe numbers or percentages of exposures for the one or more advertisements with respect to the owners of various types of client devices. For example, an “exposure” metric may indicate that 2,000 APPLE® IPHONE® 5 owners have viewed a particular advertisement while 300 owners of the NOKIA® LUMIA® 900 have viewed the same advertisement. In another embodiment, generated metrics may measures the effectiveness of the one or more advertisements on owners of the various types of client devices. For example, an advertisement may promote a particular automobile model. A “conversion” metric may indicate the effectiveness of the advertisement on the owners of the APPLE® IPHONE® 5 in facilitating the owners to perform searches for information about the automobile model.

In one embodiment, metrics generated by the social networking system may describe the effectiveness of the one or more advertisements in promoting ownership of particular types of client devices. More specifically, the social networking system generates conversion metrics measuring the effect of the advertisements in driving the subsequent purchase and/or ownership of a particular type of client device. For example, a metric may describe the effectiveness of an advertisement promoting the SAMSUNG GALAXY TAB® 2 in encouraging ownership of the SAMSUNG GALAXY TAB® 2. To generate the metric, the social networking system may identify users accessing their account from a SAMSUNG GALAXY TAB® 2 after being presented with an advertisement for the SAMSUNG GALAXY TAB® 2.

In one embodiment, the metrics generated by the social networking system may provide information regarding insights into market share or ownership shifts. To generate such metrics, the social networking system may identify client devices previously owned by users. The social networking system may additionally identify client devices currently owned by the same users. Based on comparisons of the identified information, the social network system may generate metrics indicating shifts or changes related to the ownership of the client devices.

Identifying owners of client devices and generating metrics based on the identified device ownership in the manner described enable advertising metrics relating to client device ownership to be efficiently and accurately generated. Hence, advertisers can obtain a better understanding of the effectiveness of their advertisements as related to client device ownership. This allows advertisers to better tailor their advertisements to meet various advertising objectives.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is a high level block diagram illustrating a system environment suitable for operation of a social networking system, in accordance with an embodiment of the invention.

FIG. 2 is a block diagram of various components of a social networking system, in accordance with an embodiment of the invention.

FIG. 3 is a flow chart of a process for generating advertising metrics according to client device ownership, in accordance with an embodiment of the invention.

FIG. 4 is a flow chart of a process for generating advertising metrics measuring advertising impact on client device ownership, in accordance with an embodiment of the invention.

The Figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Architecture

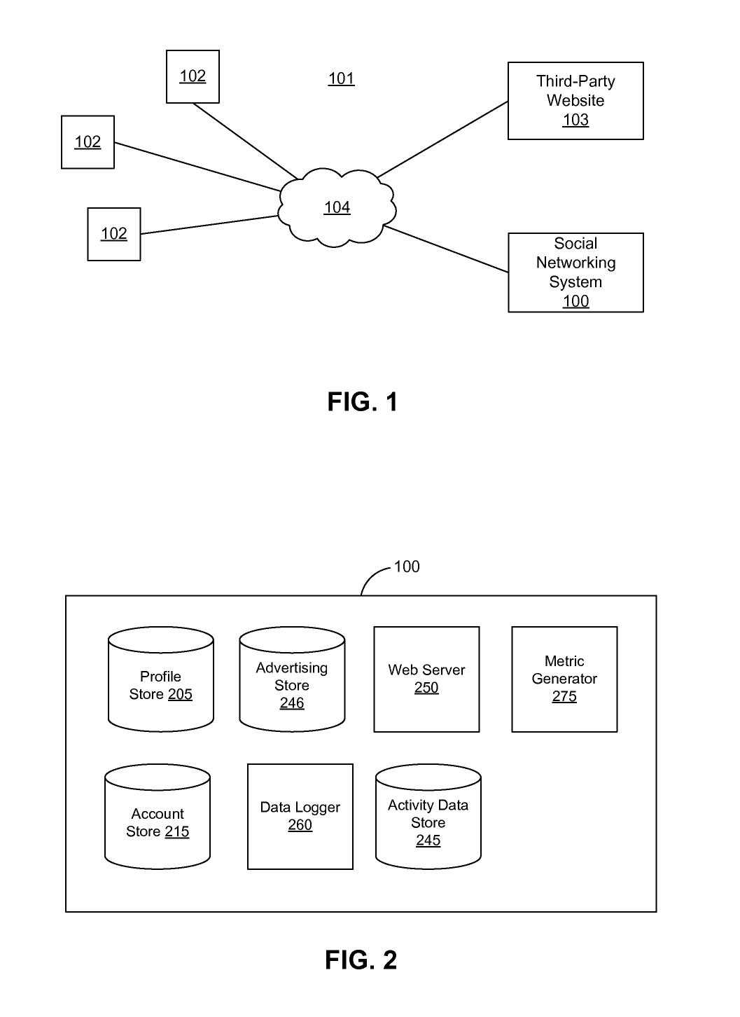

FIG. 1 is a high level block diagram illustrating a system environment 101 suitable for operation of a social networking system 100. In one aspect, the system environment 101 enables the automatic generation of advertising metrics based on client device ownership. As shown in FIG. 1, the system environment includes one or more client devices 102, one or more third-party websites 103, a social networking system 100, and a network 104. While FIG. 1 shows three client devices 102 and one third-party website 103, it should be appreciated that any number of these entities (including millions) can be included. In alternative configurations, different entities can also be included in the system environment 101.

The client devices 102 are one or more computing devices that receive user input, as well as transmit and receive data via the network 104 to the social networking system 100. Some of the client devices 102 include an installed native software application for accessing the social networking system 100. The native software application may be a software application configured to be executed within a computing environment specific to a client device 102. For example, the native software application is configured to be executed by an operating system executed by the client device 102. In some embodiments, the client device 102 includes various native software applications for accessing different entities, such as various third-party websites 103 and/or the social networking system 100.

One or more of the client devices 102 may include a web browsing application, such as APPLE® SAFARI°, MICROSOFT® INTERNET EXPLORER®, GOOGLE® Chrome, Mozilla FIREFOX®, etc. The web browsing application allows the client device 102 to exchange information with one or more third-party websites 103 and/or with the social networking system 100 via the network 104. The web browsing application included on a client device 102 may depend on one or more attributes of the client device 102, such as an operating system used by the client device 102, or any other suitable attribute of the client device 102.

Each of the client devices 102 provides identifying information associated with a user when accessing the social networking system 100. The identifying information is used by the social networking system 100 to identify a user account associated with the user of a client device 102. Examples of identifying information include a username, a password, a login credential, or other information suitable for identifying a user account stored by the social networking system 100. Further, a client device 102 may provide information describing one or more attributes of the client device 102 when communicating with the social networking system 100. For example, the attribute information sent to the social networking system 100 includes data describing a model of the client device 102, a part number associated with the client device 102, a manufacturer associated with the client device 102, an operating system associated with the client device 102, a native application used by the client device 102 to access the social networking system 100, or any other suitable information. As further described below, the social networking system 100 uses one or more of the attributes of the client device 102 to generate one or more metrics for advertisements.

Examples of client devices 102 include desktop computers, laptop computers, tablet computers (pads), mobile phones, personal digital assistants (PDAs), gaming devices, appliances (e.g., refrigerators), vehicles (e.g., automobiles, boats, airplanes), or any other devices including computing functionality and data communication capabilities. The client devices 102 are configured to communicate via the network 104, which may be any combination of local area and/or wide area networks using both wired and wireless communication systems. For example, the network 104 may be any combination of the Internet, a mobile network, a local area network (LAN), a wired or wireless network, a private network, a virtual private network and/or any other suitable communication mechanisms. The third-party website 103 is coupled to the network 104 to communicate with the social networking system 100 and/or with one or more client devices 102.

The social networking system 100 is a computing system allowing its users to communicate or otherwise interact with each other and access content as described herein. In one embodiment, the social networking system 100 stores user accounts for one or more social networking system users. Associated with the user accounts, the social networking system 100 stores user profiles describing the social networking system users, including biographic, demographic, and other types of descriptive information, such as work experience, educational history, hobbies or preferences, location, and the like. Using information in the user profiles, connections between user profiles, and actions associated with user profiles, the social networking system 100 maintains a social graph describing connections between various users. Each connection may define a particular relationship between two users, such as a friendship relationship, a fan relationship, a follower relationship, etc. The social networking system 100 additionally stores other objects, such as fan pages, events, groups, advertisements, general postings, etc.

FIG. 2 is an example block diagram of various components of one embodiment of the social networking system 100. In alternative configurations, different and/or additional components may be included in the system 100.

The account store 215 stores information for user accounts of various social networking system users. The information for a user account may include user identifiers, a username, a user password, user settings (e.g., user privacy settings), identifiers of client devices 102 associated with a user, or other similar information. Each user account is associated with a corresponding social network user profile. Data included in the account store 215 may be encrypted or otherwise secured to prevent unauthorized access to the data.

The profile store 205 stores user profiles associated with social networking system users. Each user profile may include demographic and other information associated with a particular user. Examples of information associated with a user include: the user's gender, age, geographical location, education or professional affiliations, group memberships, interests, activities, income, nationality, race, and/or the like. For example, a stored user profile indicates that a particular user is 25 years old, lives in Cheyenne, works as a doctor, and enjoys horseback riding. In one embodiment, each user profile may also be associated with and/or include information about a user's connections (e.g., friends) in the social networking system 100 to other users of the social networking system 100. In one embodiment, data included in the profile store 205 may be encrypted or otherwise secured to prevent unauthorized access.

The activity data store 245 stores information describing one or more activities of users through the social networking system 100 and/or external to the social networking system 100. The information stored by the activity data store 245 describes any suitable online or offline activities. For example, the activity data store 245 includes data describing uses of a client device 102 by a user to login to or otherwise access the social networking system 100.

Information included in the activity data store 245 may also identify types of actions performed by users. Example types of activities include: expressing a preference for an object (i.e., “liking” the object), expressing a desire for an object (i.e., “wanting” the object), commenting on an object, sharing an object, searching for an object, viewing an object, posting content, and generating content and/or advertisements. The activity data store 245 further includes data describing actions performed with respect to the users, such as presentation of content to a user and/or exposure of one or more advertisements to the user. Additionally, the activity data store may store certain attributes of a client device 102 used to perform an activity or otherwise associated with an activity (e.g., a model of the client device 102, a part number associated with the client device 102, a manufacturer associated with the client device 102, an operating system associated with the client device 102, a native application used by the client device 102 to access the social networking system 100, etc.).

In one embodiment, the activity data store 245 also stores polling data and/or information regarding purchases by social networking system users. Location data associated with users may be stored in the activity data store 245. For example, the activity data store 245 stores data identifying a geographic location and a time associated with the geographic location indicating a user is at the geographic location. The geographic information may be received via an explicit communication from the user (e.g., a “check-in”), via communication from a client device 102, or via any suitable action. To prevent unauthorized access, data in the activity data store 245 may be encrypted, or otherwise secured.

The advertising store 246 stores data describing one or more advertisements and presentation of one or more advertisements to social networking system users. For example, the advertising store 246 stores an advertisement, data identifying an advertiser associated with the advertisement and other parameters associated with the advertisement. Additionally, targeting criteria may be stored and associated with an advertisement. Targeting criteria identifies one or more characteristics of a user eligible to be presented an associated advertisement. For example, targeting criteria specifies attributes from a user profile, such as user demographics (e.g., gender, age, geographical region, stated interests or preferences, professional, personal, or educational affiliations, income or other data included in a user profile). Different types of user affiliations may be specified by targeting criteria, such as memberships in groups, lists, networks, forums, and clubs within the social networking system. For example, an advertisement may be targeted towards graduates from a list of specific colleges and universities.

Targeting criteria may also specify attributes of a user's actions inside and/or outside of the social networking system 100. Example targeting criteria based on user actions may specify frequency of use of the social networking system 100, length of time logged-in to the social networking system 100, access or use of specific features of the social networking system 100 or destinations outside the social networking system 100. For example, an advertisement may be targeted to users who have used the social networking system 100 at least five times per week for the past month, and who have used a gift giving application within the last three days. Hence, the targeting criteria may comprise any data maintained by the social networking system 100 or any suitable combination of data maintained by the social networking system 100.

The web server 250 exchanges data between the social networking system 100, one or more of the client devices 102, and/or one or more third-party websites 130 via the network 104. For example, the web server 250 includes a mail server or other messaging functionality for receiving and routing messages between the social networking system 100 and the client devices 102 or third-party websites 103. The messages can be instant messages, queued messages (e.g., email), short message service (SMS) messages, multimedia messaging service (MMS) messages, or any other suitable type of message. In one embodiment, the web server 250 may receive a request for content to be displayed to a user of a client device 102, and the content is presented along with one or more advertisements; the content and/or advertisements are provided to the client device 102 via the web server 250.

In one embodiment, the web server 250 serves one or more web pages and/or other content that are collectively referred to as a website of the social networking system 100. The web server 250 allows users, via web browsing applications or native applications installed on the client devices 102, to access functionalities of the social networking system 100. In various embodiments, the web server 250 may use one or more application programming interfaces (APIs) to allow native software applications installed on the client devices 102 to directly access the functionalities of the social networking system 100.

Data received by the web server 250 from a client device 102 includes information specifying certain attributes of the client device 102 (e.g., a model of the client device 102, a part number associated with the client device 102, a manufacturer associated with the client device 102, an operating system associated with the client device 102, a native application used by the client device 102 to access the social networking system 100, etc.). Data received from a client device 102 also includes information identifying a user account associated with a client device user, such as a username.

The data logger 260 identifies and stores information describing one or more activities performed through the social networking system 100 and/or external to the social networking system 100 in the activity data store 245. For example the data logger 260 logs information regarding an action performed by a user via the social networking system 100 in the activity data store 245. As another example, the data logger 260 logs information regarding presentation of an advertisement to a user via the social networking system 100 in the activity data store 245. In one embodiment, the data logger 260 logs identification information (e.g., a username) for the user associated with an action to the activity data store 245. Additional information, such as data describing a client device 102 associated with the user or with the action (e.g., a device model identifier) may also be logged by the data logger 260.

The metric generator 275 generates metrics for one or more advertisements based at least in part on client device ownership. To generate the metrics, the metric generator 275 identifies users of the social networking system as owners of the client devices 102. In one aspect, the metric generator 275 identifies the owners based on accesses performed to the owners' user accounts over the social networking system by native software applications and/or web browsing applications installed on the client devices 102. Identification may also be based on one or more social signals. After identifying the owners of the client devices 102, the metric generator 275 identifies one or more exposures of the owners to one or more advertisements. Based on the identified owners of the client devices 102 and the identified exposures to the advertisements, the metric generator 275 generates metrics for the one or more advertisements with respect to the identified owners. The metrics may be categorized based on different attributes of the client devices 102, such as by client device model, part number, etc.

### Process for Generating Advertising Metrics According to Client Device Ownership

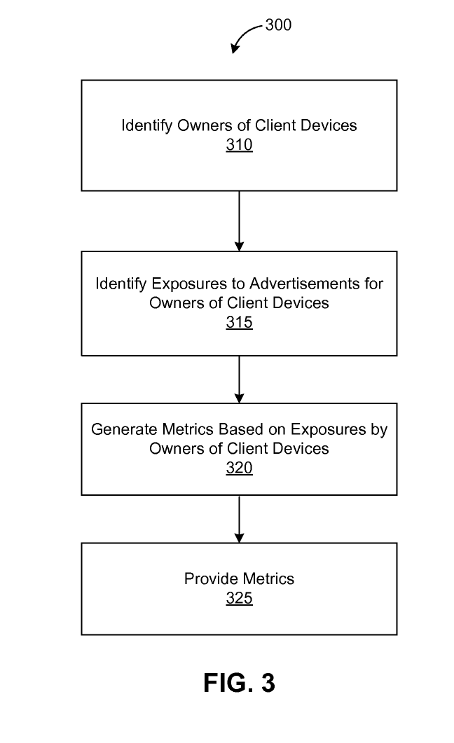

FIG. 3 illustrates one embodiment of a process 300 for generating advertising metrics according to client device ownership. Other embodiments can perform the steps of the process 300 in different orders and can include different, additional, and/or fewer steps.

The social networking system 100 identifies 310 users of the social networking system 100 owning one or more client devices 102. An owner of a particular client device 102 may be a social networking system user that is the primary user of a client device 102. An owner may alternatively or additionally be a social networking system user that is a regular user of a client device 102, so multiple owners may be identified based on usage of a client device 102.

In one aspect, one or more ownership identification policies or rules are used to identify 310 a user as an owner of a client device 102. In one implementation, the social networking system 100 identifies a user as an owner based on communications from a native software application of the social networking system 100 installed on a client device 102 used by the user to access the social networking system 100. More specifically, communications from the native software application may include user identifying information (e.g., a user id, username, user password, etc.) for accessing the social networking system 100. From the user identifying information, the social networking system 100 identifies a user account of the user. The communications from the native software application may further include attribute information regarding the native software application and/or the client device 102 on which the native software application is installed. Such attribute information may indicate, for example, the operating system of the native software application, the platform of the native software application, the version of the native software application, the model of the client device, etc. Based on the identifying information and the attribute information, the social networking system 100 determines a client device 102 owned by the user.

The social networking system 100 may additionally or alternatively identify a user as an owner based on communications from a web browsing application installed on the client device 102 used by the user to access the website of the social networking system 100. Communications received from a web browsing application include user identifying information for accessing the social networking system 100. The communications may further include attribute information regarding the web browsing application and/or the client device 102 on which the web browsing application is installed. Based on the identifying information and the attribute information, the social networking system 100 determines a client device 102 owned by the user.

In some embodiments, one or more threshold criteria are also specified for identifying 310 a user as an owner of a client device 102. In some implementations, a user is identified 310 as an owner of a client device 102 if the user has used the client device 102 at least a threshold number or percentage of times to access the social networking system using the user account of the user within a given time period (e.g., within a day, week, month, year, etc.). As a specific example, if a user has accessed the social networking system more than twenty times using a particular client device 102, the user is identified as an owner of the client device 102. As another example, if at least 45% of a user's accesses to the social networking system 100 are performed using a particular client device 102, the user is identified 310 as an owner of the particular client device 102. Alternatively, a user is identified 310 as an owner of a particular client device 102 if the user has used the client device 102 to access the social networking system more than any other client device 102 within a given time period.

In certain implementations, a user is identified 310 as an owner of a client device 102 if the client device 102 has been used by the user more than any other user to access the social networking system 100. For example, a particular client device 102 may be an APPLE® IPHONE®. The client device may have been used by a first user 300 times to access the social networking system 100 and by a second user 60 times to access the social networking system 100. Because the first user has used the client device 102 more than the second user to access the social networking system 100 using the client device 102, the social networking system 100 identifies the first user as an owner of the APPLE® IPHONE®. It will be appreciated that any suitable combination of threshold criteria may be combined to identify 310 a user as an owner of a particular type of client device 102.

In one implementation, one or more social signals from data maintained by the social networking system 100 may be used to identify a user as the owner of a particular type of client device 102. More specifically, based on analysis of user profile information associated with the user, other users connected to the user, the actions of the user, and/or any other suitable information of the user maintained by the social networking system 100, a user may be identified 310 as an owner of a particular type of client device 102. For example, a first user may have been identified 310 as the owner of a particular client device 102. Subsequently, a second user not connected to the first user accesses the social networking system 100 multiple times using the particular client device 102. Based on user profiles associated with the first user and the second user, the social networking system 100 may determine that ownership of the client device 102 has changed from the first user to the second user.

Information for the client device 102 owned by a user is stored in or in association with the user account and/or user profile of the user. For example, the user account of the owner in the account store 215 is modified to include information for the owned client device 102. Examples of information of a client device stored in the account store 215 include: a model of the client device 102, a part number of the client device 102, an operating system of the client device 102, a manufacturer of the client device 102, a unique identifier for the client device 102, a unique identifier for the native application or web browser installed on the client device 102, or any other suitable information identifying the client device 102.

Exposures of one or more advertisements to the owners of the client devices 102 are subsequently identified 315. For example, exposures of client device owners to one or more advertisements via the owned client device 102, via devices not identified as being owned by the owners, via billboards, via periodicals, via television, via the social networking system 100, via third party websites 102, or via any suitable channel are identified 315. For example, exposures to one or more advertisements via an APPLE® IPHONE® 4 are identified for a user identified as owning the APPLE® IPHONE® 4. As another example, exposures to an owner of a client device to an advertisement via a third-party website 103 are identified 315.

In one embodiment, exposures to advertisements are identified 315 based on inferences derived from various social signals and/or other suitable data. For example, an owner of a particular client device 102 is identified 315 as having been exposed to one or more advertisements based on a current location of the owner included in the user's user profile and location information for physical locations associated with the advertisements (e.g., a freeway billboard of an advertisement). If the current location of the client device owner is within a threshold distance of a physical location associated with an advertisement, the client device owner is identified 315 as having been exposed to the advertisement.

After identifying the exposures of the one or more advertisements to the owners, one or more metrics for the one or more advertisements are generated 320 based on the exposures of the client device owners to the one or more advertisements. One or more of the metrics may use certain attributes of the client devices 102. For example, metrics may be generated for different types of client devices 102 based on model attributes, product number attributes, manufacturer attributes, or operating system attributes.

In one implementation, to generate the metrics, additional data associated with owners of the client devices 102 is obtained. In one embodiment, the data is obtained based on answers to polls provided to users identified as client device owners 102. For example, a poll includes questions asking for impressions about the advertisements to which a client device user was exposed or asking for impressions about a brand, product, or service associated with the advertisements, or other suitable information.

The obtained additional data may also or alternatively include information based on actions of the identified owners logged by the social networking system 100, which may include actions internal to or external to the social networking system 100. The actions may involve one or more of the presented advertisements, content associated with a presented advertisement, an advertiser associated with a presented advertisement, or any other suitable information. Examples of actions include: posting user generated content, liking content, commenting on content, searching for content, posting statuses, establishing social networking connections, posting of reviews, joining of groups, etc.

The obtained additional data may also or alternatively include purchase transaction data. The purchase transaction data may indicate purchases made by the owners over the social networking system 100 and/or external to the system 100, where the purchases are for products or services associated with the one or more advertisements. For example, the purchase transaction data may identify a purchase by a client device owner of an automobile promoted by the one or more advertisements. In one embodiment, the purchase transaction data is provided subject to user-specified privacy settings from a user profile, allowing users to regulate accessibility to purchase transaction data.

Based on the obtained data associated with client device owners, the one or more metrics for the one or more advertisements are generated 320.

In one embodiment, the generated metrics include exposure or impression numbers for the one or more advertisements with respect to the owners of different types of client devices 102. Each generated exposure number indicates the number of times one or more of the advertisements have been viewed by owners of a type of client device 102 using the client device 102. For example, an exposure number indicates the number of times the one or more advertisements have been viewed by owners of an APPLE® IPHONE® 5 via an APPLE® IPHONE® 5. In other embodiments, a generated exposure numbers indicates the number of times the one or more advertisements have been viewed by owners of different types of client devices 102 regardless of the device used to view the advertisements (e.g., the exposure number includes exposures via a client device 102 owned by a user and via client devices not identified as being owned by an owner or other sources).

In another embodiment, the generated metrics include exposure percentages for the one or more advertisements with respect to the owners of the different types of client devices 102. For example, each generated exposure percentage indicates the percentage of the owners of a particular type of client devices 102 that was exposed to the one or more advertisements over the client device 102. For example, an exposure percentage specifies that 30% of the owners of an LG® ESCAPE™ mobile phone were exposed to the one or more advertisements via an LG® ESCAPE™ mobile phone. Another exposure percentage may indicate that 75% of owners of client devices 102 running the APPLE® iOS® operating system were exposed to the one or more advertisements over client devices 102 running the APPLE® iOS® operating system. In other embodiments, the generated exposure percentages identify the percentage of owners of the client devices 102 that were exposed to the one or more advertisements regardless of the source of the exposure.

In one embodiment, the generated metrics may describe conversion events (e.g., purchases, accessing of advertisements, accessing of landing pages associated with an advertisement) with respect to owners of different types of client devices 102. In the embodiment, such conversion metrics measure the effectiveness of the one or more advertisements in facilitating the owners of the different types of client devices 102 to perform some action. For example, the metrics may measure the impact of the advertisements in causing owners to purchase products associated with the advertisements, perform certain actions (e.g., commenting on, liking, sharing, searching for) on content associated with the advertisements, etc.

In the embodiment, such metrics are generated using various holdout and sample groups including owners of the client devices 102. For example, owners of various types of client devices 102 are randomly or pseudo-randomly assigned to holdout or sample groups. Each of the holdout and sample groups may include users with identical or similar demographic characteristics to facilitate comparisons between the groups. Owners assigned to a sample group are presented with the one or more of the advertisements while owners in a holdout group are not presented with the advertisements.

Based on differences in the previously obtained data (e.g., polling data, purchase transaction data, observed actions, etc.) between owners of types of client devices in the holdout group and owners of corresponding types of client devices in the sample group, metrics indicating the impact of the advertisements on the owners of the different types of client devices 102 are generated 320. For example, an advertisement promotes a particular brand of shoes, so a metric indicating the impact of the advertisement on purchases of the brand of shoes by owners of the APPLE® IPHONE®5 is generated 320. The metric may indicate a rate at which APPLE® IPHONE® 5 owners purchase the shoes after being presented with the advertisement. A similar metric may also be generated for owners of the NOKIA® LUMIA®. Such metrics may be based on the obtained purchase data for the owners. Additional details regarding the generation of metrics using holdout groups may be found in U.S. patent application Ser. No. 13/658,480, filed on Oct. 23, 2012, titled “Determining Advertising Effectiveness Based on Observed Actions in a Social Networking System,” which is hereby incorporated by reference in its entirety. Any other suitable metrics for the one or more advertisements may be generated 320 based on the identified client device ownership. The generated metrics are provided 325 to an advertiser or any other suitable entity.

In one embodiment, the metrics may describe market share or ownership shifts related to various client devices. In generating such metrics, client devices previously owned by various users are identified. The client devices currently owned by the same users are also identified. Based on the identified information, differences between those client devices previously owned by the users and those client devices currently owned by the users are analyzed. For example, a difference between the number/percentage of users previously owning a particular type of client device and the number/percentage of users currently owning the particular type of client device can be computed as part of the analysis. Based on the analysis, metrics describing market shifts or changes related to ownership of the client devices are generated.

As a specific example, the social networking system may identify users that previously owned the APPLE® IPHONE® 3. The social networking system may further identify the client devices now owned by the users, such as the APPLE® IPHONE® 4S and APPLE® IPHONE® 5. Based on such information, the social networking system can provide metrics indicating the manner in which ownership or market share of the APPLE® IPHONE® 3 has changed or shifted to other types of client devices.

As another specific example, the social networking system may identify users that previously owned ANDROID® based client devices associated with a particular service provider. The social networking system may additionally identify those client devices currently owned by the same users, and the service providers associated with the currently owned client devices. Based on such information, the social networking system may generate metrics describing the manner in which the market share of the service provider has shifted over time with respect to owners of ANDROID® based client devices.

### Process for Generating Metrics Measuring Advertising Impact on Client Device Ownership

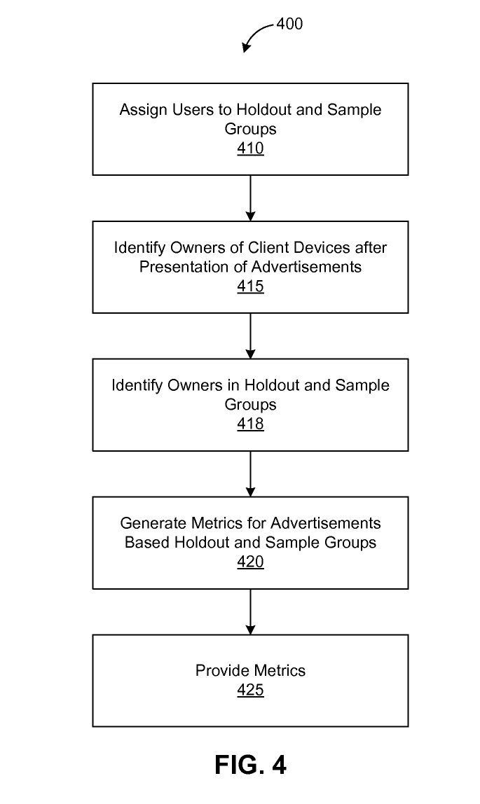

FIG. 4 illustrates one embodiment of a process 400 for generating advertising metrics measuring advertising impact based on client device ownership. Other embodiments can perform the steps of the process 400 in different orders and can include different, additional, and/or fewer steps.

In the process, social networking system users are randomly or pseudo-randomly assigned 410 to a sample group or holdout group for one or more advertisements. Each of the holdout and sample groups may include users with identical or similar demographic characteristics. In one aspect, each of the one or more advertisements may be associated with a particular type of client device 102, such as a particular mobile phone model. For example, the one or more advertisements may promote a particular type of client device 102.

After the client device owners are assigned 410 to the holdout group or to the sample group, the one or more advertisements are presented to the users in the sample group and withheld from being presented to users in the holdout group. More specifically, when an advertisement from the one or more advertisements is selected for presentation to a user, the social networking system 100 determines whether the user is assigned to the holdout group or the sample group. If the user is assigned to the holdout group, the user is not presented with the advertisement. If the user is assigned to the sample group, the user is presented with the advertisement.

After presentation of the one or more advertisements, one or more owners of client devices 102 of the particular type associated with the one or more advertisements are identified 415 via the social networking system 100. For example, for advertisements promoting the APPLE® IPHONE® 5 model, users of the social networking system 100 indicated as owning an APPLE® IPHONE® 5 are identified 415. Client device owners may be identified 415 as described above in conjunction with the process described in FIG. 3. For example, owners of client devices 102 may be identified based on accesses to the social networking system 100 by native software applications and/or web browsing applications installed on client devices 102.

Thereafter, client device owners included in the sample group and client device owners included in the holdout group are identified 418 from the identified owners of the client devices 102 associated with the one or more advertisements. Based on the identified owners for the holdout and sample groups, conversion metrics indicating the effectiveness of the advertisements in facilitating ownership of the type of client device 102 are generated 420.

To generate the metrics, in one embodiment, the number or percentage of users in the holdout group identified as owning units of the client device 102 of the type is identified. The number or percentage of users in the sample group identified as owning units of the client device 102 of the type is also identified. Thereafter, differences in the number or percentage of users owning a unit of the client device 102 in the sample group is compared to the number or percentage of users owning a unit of the client device 102 in the holdout group. Based on the comparison, one or more metrics providing a measure of the effect of the advertisements on client device ownership are generated 420. For example, it may be determined that 10% of the users in the sample group own an APPLE® IPHONE® 5 after the advertisements were presented, while 5% of the users in the holdout group own an APPLE® IPHONE® 5 after the advertisements were presented. Hence, a generated metric may indicate that the advertisements increased ownership of the APPLE® IPHONE® 5 by five percentage points.

To generate the metrics, in another embodiment, the number or percentage of users in the holdout group identified as owning a client device 102 of the type prior to presentation of advertisements is determined. The number or percentage of users in the holdout group identified as owning a client device 102 of the type after presentation of the advertisements is also determined. Thereafter, the number or percentage related to ownership prior to presentation of the advertisements and the number or percentage related to ownership after presentation of the advertisements are compared. For example, a difference value can be determined between the two numbers or two percentages of the holdout group.

In addition, the number or percentage of users in the sample group identified as owning a client device 102 of the type prior to presentation of advertisements is determined. The number or percentage of users in the sample group identified as owning a client device 102 of the type after presentation of the advertisements is also determined. Thereafter, the number or percentage related to ownership prior to presentation of the advertisements and the number or percentage related to ownership after presentation of the advertisements are compared. For example, a difference value can be determined between the two numbers or two percentages of the sample group. Thereafter, the metrics may be generated by comparing and contrasting the difference value for the holdout group and the difference value for the sample group.

Additional details regarding the use of holdout groups in generating advertising metrics may be found in U.S. patent application Ser. No. 13/658,480, filed on Oct. 23, 2012, titled “Determining Advertising Effectiveness Based on Observed Actions in a Social Networking System,” which is hereby incorporated by reference in its entirety. The generated metrics are provided 425 to an advertiser or another suitable entity.

In one embodiment, rather than identifying specific client devices (i.e., specific instances or units of client devices) owned by users, the social networking system 100 identifies types of client devices owned by users. In such instances, a specific instance of a client device 102 is not associated with a particular user. Rather, a type (e.g., a model) of the client device 102 is associated with the particular user.

In one embodiment, in addition to identifying client device ownership, the social networking system 100 identifies service providers utilized by and/or otherwise associated with the client devices owned by users. In such instances, the metrics generated by the social networking system 100 may additionally include service provider type as a dimension. For example, the metrics generated by the social networking system 100 may describe the number or percentage of users identified as being customers of AT&T® based on the users' ownership of client devices associated with AT&T®.

In yet another embodiment, the social networking system 100 associates or merges various types of information available over the social networking system with client device ownership information. For example, the social networking system 100 may associate user profile information (e.g., user identities, user interests, education information, demographic information, etc.), user action information (user approval actions, user commenting actions, etc.), user social network connection information (e.g., user friendship information), and/or any other information of a social networking system with identified client device owners. Based on such information, the social networking system 100 may identify various relationships or links between client device ownership and social networking system information. As a specific example, the social networking system 100 may associate user profile information with client device ownership information to identify owners of a particular type of client device that are also interested in sports as stated in the owners' social networking system user profiles. As another example, the social networking system 100 may associate user action information to identify customers of particular client device service providers that have provided approval for (e.g., “liked”) certain advertisements presented over the social networking system 100.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may include a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method comprising:
receiving communications from one or more client devices, each communication including information identifying a user and describing one or more characteristics of a client device;
identifying one or more social networking system users owning a particular type of client device based on the information identifying the users and characteristics of the client devices included in the received communications;
associating the particular type of client device with one or more user accounts of the one or more social networking system users identified as owning the particular type of client device;
identifying one or more exposures of the one or more social networking system users identified as owning the particular type of client device to one or more advertisements; and
generating one or more metrics for the one or more advertisements with respect to the social networking system users identified as owning the particular type of client device based on the one or more exposures.

2. The computer-implemented method of claim 1, wherein at least one of the one or more characteristics is selected from a group consisting of: a client device model, a client device product number, a client device manufacturer, and a client device operating system.

3. The computer-implemented method of claim 1, wherein the information describing the one or more characteristics of the client device comprises information identifying a software application installed on the client device and configured to access the social networking system.

4. The computer-implemented method of claim 1, wherein identifying the one or more social networking system users owning the particular type of client device comprises:
retrieving stored communications associated with a particular social networking system user and received by a social networking system, wherein each stored communication includes one or more client device characteristics;
determining a number of the stored communications including client device characteristics of the particular type of client device; and
identifying the particular social networking user as owning the particular type of client device based on the number of stored communications including client device characteristics of the particular type of client device meeting at least a threshold number.

5. The computer-implemented method of claim 1, wherein identifying the one or more social networking system users owning the particular type of client device comprises:
retrieving stored communications associated with a particular social networking system user and received by a social networking system, wherein each stored communication includes one or more client device characteristics;
determining a percentage of the stored communications that include client device characteristics of the particular type of client device; and
identifying the particular social networking user as owning the particular type of client device based on the percentage of the stored communications that include client device characteristics of the particular type of client device meeting at least a threshold percentage.

6. The computer-implemented method of claim 1, wherein identifying the one or more social networking system users owning the particular type of client device comprises:
accessing user profiles associated with one or more additional users connected to a particular user;
identifying one or more social signals associated with the particular user based on the user profiles associated with the one or more additional users connected to the particular user; and
identifying the particular user as owning the particular type of client device based at least in part on the one or more social signals.

7. The computer-implemented method of claim 1, wherein generating the one or more metrics comprises:
obtaining purchase transaction data for the social networking system users identified as owning the particular type of client device, the purchase transaction data associated with content included in the one or more advertisements; and
generating, based on the purchase transaction data, a metric describing purchases associated with content included in the one or more advertisements for the social networking system users identified as owning the type of client device.

8. The computer-implemented method of claim 1, wherein generating the one or more metrics comprises:
identifying one or more user actions performed by social networking system users identified as owning the particular type of client device; and
generating a metric based on the actions performed by social networking system users identified as owning the particular type of client device.

9. The computer-implemented method of claim 1, wherein generating the one or more metrics comprises:
providing a poll to the one or more social networking system users identified as owning the particular type of client device, the poll requesting information associated with content of the advertisement; and
generating a metric based on data from responses to the poll from at least a subset of the one or more social networking system users identified as owning the particular type of client device.

10. The computer-implemented method of claim 1, wherein at least one of the one or more metrics describes a number of exposures of the one or more advertisements to the one or more social networking system users identified as owning the particular type of client device.

11. A computer-implemented method comprising:
receiving communications from a plurality of client devices to a social networking system, each communication describing a software application executed by a client device and a user account associated with the software application;
identifying a plurality of social networking system users each as an owner of a client device of a particular type based at least in part on the software applications and the user accounts described by the received communications;
identifying one or more advertisements presented to the social networking system users each identified as owning a client device of the particular type;
retrieving data associated with the social networking system users, the retrieved data selected from a group consisting of purchase transaction data, polling data, and user activity data; and
generating one or more metrics associated with the one or more advertisements based at least in part on the retrieved data for the social networking system users each identified as owning a client device of the particular type.

12. The computer-implemented method of claim 11, wherein client devices of the particular type share at least a same client device model, a same client device product number, or a same client device manufacturer.

13. The computer-implemented method of claim 11, wherein the software application is configured to access the social networking system.

14. The computer-implemented method of claim 11, wherein the one or more metrics indicates an effectiveness of the one or more advertisements in facilitating purchases of a product by users each identified as owning a client device of the particular type.

15. The computer-implemented method of claim 11, wherein identifying the one or more advertisements comprises:
determining a location of a user based on a user profile associated with a user account maintained by the social networking system;
determining a geographic location for an advertisement from the one or more advertisements; and
determining the advertisement was presented to the user if the location of the user is within a threshold distance of the geographic location of the advertisement.

16.-20. (canceled)
